(19) United States
(12) Patent Application Publication
(10) Pub. No.: US 2006/0277763 A1
(43) Pub. Date: Dec. 14, 2006

(54) Tile nippers

(75) Inventors: Brian H. Turner, Walton, KY (US); Richard Wentz, Ft. Mitchell, KY (US)

Correspondence Address: WOOD, HERRON & EVANS, LLP, 2700 CAREW TOWER, 441 VINE STREET, CINCINNATI, OH, 45202, US

(73) Assignee: North American Tile Tool Company, Florence, KY (US)

(21) Appl. No.: 11/147,699

(22) Filed: Jun. 8, 2005

(51) Int. Cl. B26B 17/00

(52) U.S. Cl. 30/193; 30/271

(57) ABSTRACT

Elastomeric sleeves are positioned on the handles of tile nippers to maintain the tile nippers in an open position and to absorb shock. The elastomeric sleeves each include two opposed raised projections. The raised projections nearest the head of the tile nipper bias the tile nipper in an open position and provide cushioning as the tile nippers engage a piece of tile. The second raised projections contact each other as the tile nipper cuts the tile, preventing the jaws from contacting each other and reducing the jolt that the user feels as they cut the tile.

### BACKGROUND OF THE INVENTION

Tile nippers are used to break off small pieces of a tile. For example, they are used to chip off a corner of a tile. If a thin sliver of tile is to be removed from a tile, a score line can be formed with a tile cutter and the tile nippers can be used to nip away the small portion.

Tile nippers are simply hand held clipping devices. Squeezing the handles causes the jaws to engage the tile. The cutting edges of the jaws should never contact each other. As the nippers press against the surface of the tile, a fracture occurs that extends through the tile, even without the edges of the nippers extending significantly into the tile. This fracturing of the tile occurs suddenly and creates a jolt which can be uncomfortable. This could aggravate arthritis as well as potentially cause or contribute to carpel tunnel syndrome.

### SUMMARY OF THE INVENTION

The present invention is premised on the realization that positioning elastomeric sleeves on the handles of tile nippers reduces the shock created by cutting tile. The elastomeric sleeves can be used both to reduce the shock as well as to maintain the nippers in an open position without the need for a separate spring to bias the nippers in an open position.

The objects and advantages of the present invention will be further appreciated in light of the following detailed description and drawings, in which:

### BRIEF DESCRIPTION OF THE DRAWINGS

FIG. 1 is a perspective view of the present invention;

FIG. 2 is a plan side view partially broken away of the present invention;

FIG. 3 is a perspective view of a sleeve used in the present invention from a first direction; and

FIG. 4 is a perspective view of the sleeve shown in FIG. 2 from the opposite direction.

### DETAILED DESCRIPTION OF THE INVENTION

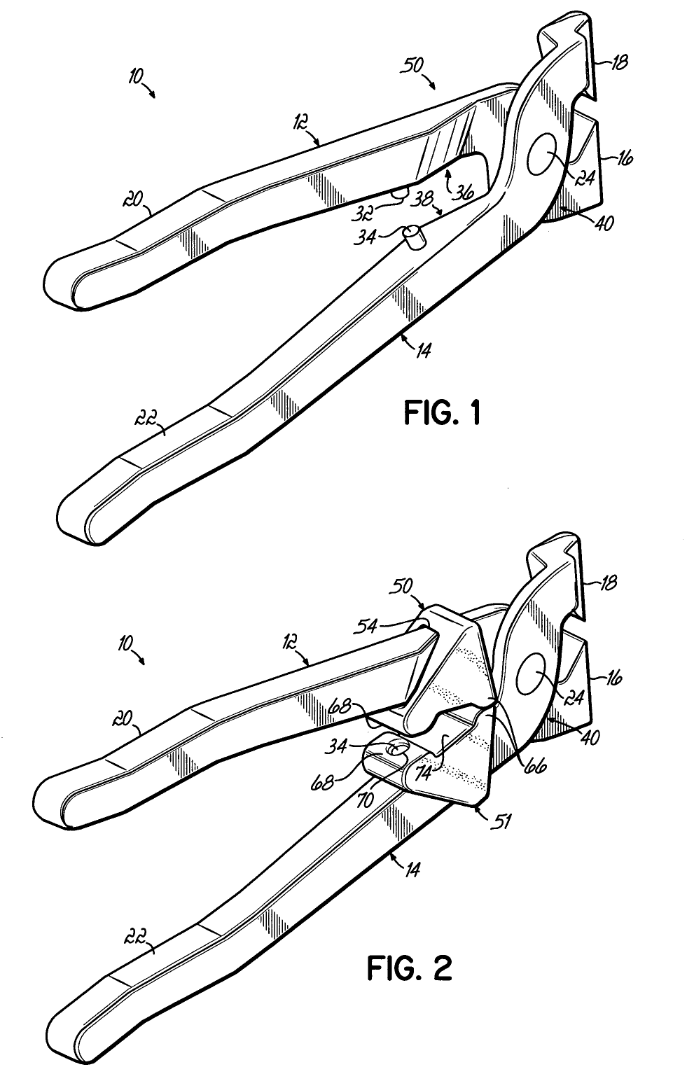

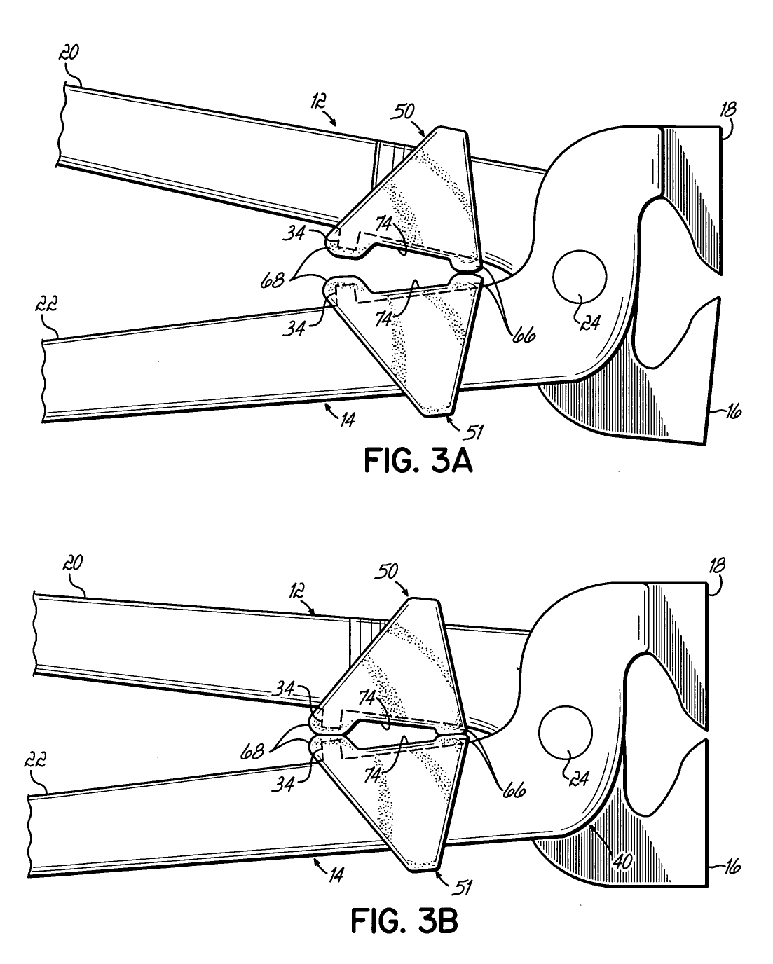

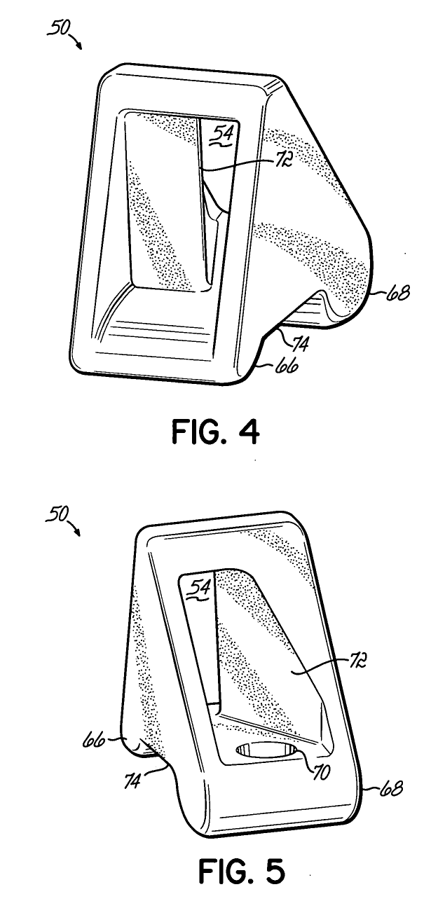

As shown in FIG. 1, the present invention is a tile nipper 10 which includes a first nipper member 12 and a second nipper member 14. The first and second nipper members 12 and 14 each include first and second jaw members 16 and 18, respectively, and first and second handles 20 and 22, respectively. The first and second nipper members are connected to each other at a pivot pin 24 which allows the handles and jaws to rotate relative to each other.

The handles 20 and 22 include inwardly facing posts 32 and 34. Handles 20 and 22 also each include tapered portions 36 and 38 where the handles narrow in an area between the posts and the pivot pin 24. This keeps the width of the nippers constant in the area 40 where the two handles overlap.

Rubber shock absorbing sleeves 50 and 51 are positioned on each handle 20 and 22. Sleeves 50 and 51 are identical and only sleeve 50 is described in detail. Sleeve 50 is triangular in shape, with a central passage 54. Sleeve 50 has an outwardly facing side 58, and an inwardly facing side 62. The inwardly facing side 62 has a first raised portion 66 and a second raised portion 68. Between the two raised portions is recessed portion 74.

The second raised portion 68 has an opening 70 through to the passageway 54. One side of passage 54 has a cross section corresponding to the cross section of the handles 20 or 22. Passage 54 has a tapered portion 72 corresponding to the tapered portion 36 of handles 20 or 22.

Sleeves 50 and 51 are forced over handles 20 and 22 with the posts 32 and 34 located in opening 70. This holds the sleeves in position.

As shown, there are no springs between the posts 32 and 34. The first raised portions 66 of the sleeves 50 and 51 on handles 20 and 22 bias the handles so that the jaws 16 and 18 are separated, i.e., in an open position.

When the nippers are used, a piece of tile is placed between the two jaws 16 and 18. The handles are squeezed toward each other. The first raised portions 66 of the sleeves 50 and 51 provide a slight resistance. During the cutting, the jaws engage the tile as the handles are squeezed harder. The tile fractures, allowing the handles to move closer together. This causes the second raised portions 68 of sleeves 50 and 51 to engage each other, which keeps the jaws from closing completely providing for a comfortable cutting action.

The sleeves are flexible and compressible. Preferably, they are formed from 70 durameter polypropylene.

Thus the sleeves of the present invention not only make the cutting action more comfortable, they also act to bias the jaws in an open position replacing the spring that is typically used to bias the jaws in an open position. Thus, the sleeves are accomplishing two purposes. This reduces expense and makes for a better tile nipper.

This has been a description of the preferred embodiment of the present invention. However, the invention itself should only be defined by the appended claims, wherein

We claim:

1. A tile nipper comprising a first and a second handle member, said handle members each including a handle portion and a jaw portion, said first and second handle members pivotally connected to each other;
first and second elastomeric sleeves each having a central passage, said sleeves positioned on said first and second handle members with said handle members positioned in said central passages, said sleeves sized to engage each other during movement of said handle thereby absorbing shock as said handle is compressed to cut tile wherein said sleeves each include first and second raised elastomeric portions and wherein said first raised elastomeric portions of said sleeves bias said jaws in an open position and wherein movement of said handles toward each other causes said second raised elastomeric portions to engage each other.

2.-3. (canceled)

4. The tile nippers claimed in claim 1 wherein said sleeves each include an inwardly extended passage and wherein said handles each include posts wherein said posts pass into said inwardly extended passages.
